(19) United States
(12) Patent Application Publication
(10) Pub. No.: US 2025/0119272 A1
(43) Pub. Date: Apr. 10, 2025

(54) DOUBLE BLIND SECRET

(71) Applicants: John E. Eisenhauer, Charlotte, NC (US); Noah L. Hughes, Iowa City, IA (US); Joseph R. Kaluzny, Harrisburg, NC (US); Eric Linn Lengvenis, Bloomington, MN (US); Anthony J. Stieber, San Francisco, CA (US)

(72) Inventors: John E. Eisenhauer, Charlotte, NC (US); Noah L. Hughes, Iowa City, IA (US); Joseph R. Kaluzny, Harrisburg, NC (US); Eric Linn Lengvenis, Bloomington, MN (US); Anthony J. Stieber, San Francisco, CA (US)

(21) Appl. No.: 18/481,024

(22) Filed: Oct. 4, 2023

(51) Int. Cl. H04L 9/06

(52) U.S. Cl. CPC H04L 9/0643

(57) ABSTRACT

Systems and methods may generally be used to identify a hashed password. An example method may include determining, using a machine learning trained model, that text data includes potentially hashed information, and in response, comparing the string to a data set of hashed strings. The method may include determining, from the comparison, that the string corresponds to a stored hashed string of the data set, and in response outputting an indication that the stored hashed string is in the text data.

### BACKGROUND

Some experts estimate that over a million passwords are stolen every week. With data breaches becoming more and more expensive, stolen passwords represent a huge risk to companies worldwide. Many sophisticated password security features are implemented by companies. One of the biggest threats to password security is via social engineering. Social engineering involves deceiving users into exposing passwords or divulging personal information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system for monitoring text data for presence of a hashed password in accordance with some examples.

FIG. 2 illustrates a block diagram for evaluating text data for presence of a hashed password in accordance with some examples.

FIG. 3 illustrates a flowchart showing a technique for evaluating text data for presence of a username in accordance with some examples.

FIG. 4 illustrates a machine learning engine for evaluating text data for password matching in accordance with some examples.

FIG. 5 illustrates a flowchart showing a technique for identifying a hashed password in text in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein may be used to detect a hashed password or other text string within text data. Hashed text strings or passwords may be stored securely, for example in a hashed repository. A hashed text string or password may be secure in storage when hashed. In some examples, a detection system may be used to determine when a hashed string appears in network traffic or on a stored or shared drive. For example, the detection system may check for a string of characters that match at least one hash characteristic. After detection of the string of characters that matches at least one hash characteristic, the string of characters may be compared to a repository of hashed strings to determine if there is a match or partial match. When a match or partial match is detected, a notification, alert, communication, etc. may be sent or issued. In some examples, a notification may be sent to a user that stored or shared the string of characters. In an example, a notification may be sent to the user's supervisor. In other examples, a notification may be sent to a user associated with the matched or partially matched hash stored in the repository. The detection system may include a machine learning trained model.

The systems and techniques described herein provide a technical solution, for example using a detection system, a machine learning model, a hashed repository, etc. to the technological problem of insecure sharing of hashed strings. A hashed string may be secure as long as it is not shared or not shared with other context information (e.g., a username, personal information, an email address, etc.). When a hashed string (e.g., a password) is shared (e.g., whether with good intentions, accidentally, or maliciously), the hashed string may become less secure. However, unhashing a hashed string to determine whether it matches a string (e.g., a password) may also cause the hashed string to become less secure.

The present systems and techniques may use a machine learning trained model to determine whether identified text data includes potentially hashed information. In response to determining that the text data includes potentially hashed information, the present systems and techniques may compare a string in the text data to data in a repository of hashed strings to determine whether the string corresponds to a stored hashed string in the repository. An indication, such as an alert, a notification, a message, etc. may be generated or output in response to a match or partial match being identified for the string.

The systems and techniques described herein provide for searching for secrets by leveraging a database or repository of secrets. This allows a detection system to look for real world data that has been encrypted. In an example, the secrets being searched for and the secrets that are found are not necessarily known by the system because they are encrypted (e.g., hashed). In some examples, a detection system may search for encrypted items such as an API Key, a password, a PIN, a passphase, a credit card number, an account number, a certificate, PHI, a biometric, PII, or any other types of restricted data. Encrypted data to search for may be stored on an endpoint and queried directly from the endpoint, in some examples.

A detection system may include a password repositories for compromised passwords. For example, password hashes from a database or Active Directory may be used to search for real passwords without having to decrypt them. The detection system may check for real passwords from Active Directory or a repository that are stored on another repository, github, locally on a workstation, sharepoint, or any other type of structured or unstructured type of data.

The detection system may check for weak passwords being used by using an Internet compromised password list that includes a list of compromised passwords, for example. Machine learning may be used to create a model based on the real passwords to score complexity for choosing new passwords. Passwords or keys being uploaded in documents to the internet or sent over email or other apps may be detected. In some examples, passwords may be blocked, even when encrypted, from being sent out through email or other communication channel.

In an example, two parties may each wish to verify possession of data by the other without revealing that data. A completely trusted third party may securely receive the data to be verified and then securely send the verification (but not necessarily the verified data) to the first two parties. However, such a completely trusted third party may not exist. In some examples, a partially trusted third party may be used. The partially trusted third party may be trusted to maintain security and follow direction, but not be trusted with the data. In these examples, the first two parties may share a cryptographic key with only with each other. This cryptographic key may be used to separately but identically encrypt each data set to be verified. In an example, secure encryption includes differently encrypted data each time. For these examples, security control (e.g., initialization vectors, nonces, salts, etc.) may be changed so that both parties encrypt possibly matching data for each data set. The first two parties do not share the encrypted data with each other. Instead the encrypted data is sent to the partially trusted third party. The partially trusted third party may compare the encrypted data from the first two parties. The partially trusted third party may notify the first two parties (or one of the first two parties) whether or what encrypted data matched (or optionally the matching encrypted data itself). The partially trusted third party is trusted such that it does not send any non-matching encrypted data to either party.

Some of the encrypted data may leak to the partially trusted third party so that entity must also be trusted to not perform any additional processing or use the leaked data. In some examples, types of data leakage may be trivial and so even a partially trusted third party may not be trusted. When there is no third party available at all then cryptographic algorithms including a zero-knowledge proof may be used. In those examples, both parties become verifiers only if they already know the information.

In some examples, a custom application may be used. The custom application may include using a secure remote password (SRP) protocol or other zero-knowledge password proof to verify each encrypted data string, such as <last name+SSN> or <account #+SSN>. SRP may use a live network connection, or may be used in a batch environment to avoid direct Internet connection security issues.

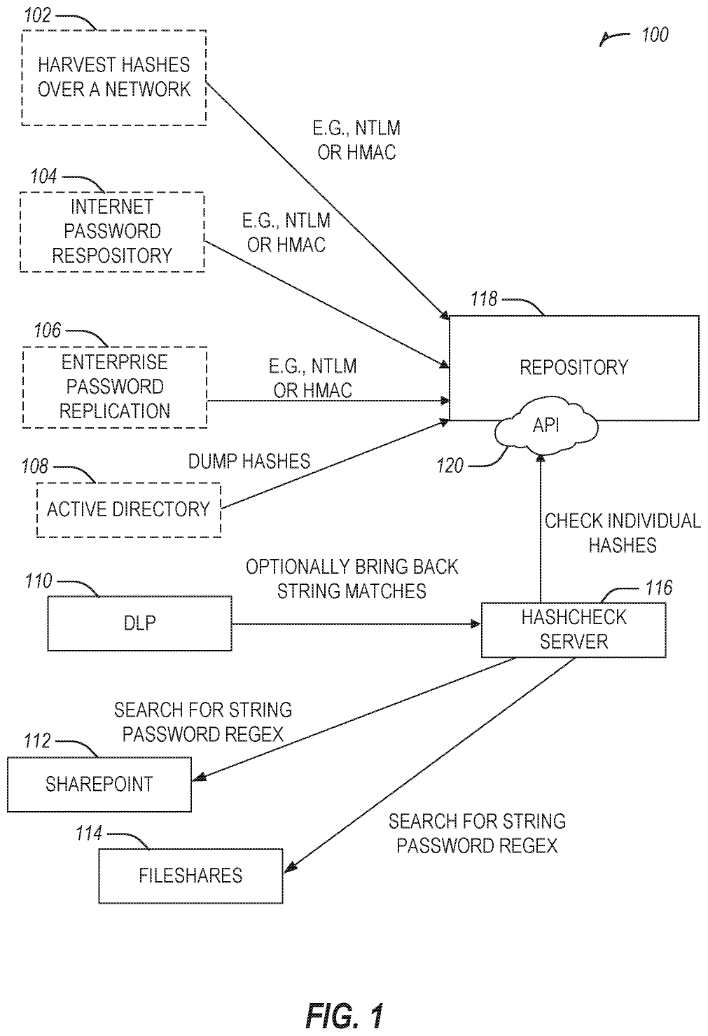

FIG. 1 illustrates a system 100 for monitoring text data for presence of a hashed password in accordance with some examples. The system 100 includes a repository 118, which may include encrypted data (e.g., hashed data). The repository 118 may be accessible via an API 120 or otherwise. The API 120 may provide information from the repository 118 to a hashcheck server 116. The hashcheck server 116 may check individual hashed or otherwise encrypted strings that are received for example from a data loss prevention (DLP) component 110 of the system 100. The DLP 110 may send string matches to the hashcheck server 116. In some examples, a local device hash (e.g., an New Technology LAN Manager (NTLM) hash) or a hash-based message authentication code (HMAC) may be used to hash data. Other hashing or encryption techniques (e.g., partially or fully homomorphic encryption) may be used for a string to be searched or stored in the repository 118 with the system 100.

Hashed or encrypted data may be obtained from various sources. For example, components 102 to 108 show example sources, such as a network harvest component 102, an internet password repository 104, an enterprise password replication repository 106, an active directory 108, or the like. These sources may be used to update or store hashed or otherwise encrypted data in the repository 118 in hashed or otherwise encrypted formats. For example, hashed data that is sent over the network may be sent from the network harvest component 102 to the active directory 108 for storage in hashed format.

In some examples, the hashcheck server 116 sends an identified string (e.g., a string that has been identified as potentially including hashed or encrypted data) to the repository 118 via the API 120 to request any data from the repository 118 that matches or partially matches the identified string. The hashcheck server 116 may receive the identified string from the DLP 110. The DLP 110 may monitor various devices or applications, such as monitoring emails, storage locations (e.g., drives, servers, devices, etc.), communication applications, text messages, documents, or the like. The DLP 110 may include a detection system to determine whether a string monitored by the DLP 110 includes encrypted data or potentially encrypted data. When there is a match, the DLP 110 may send the string to the hashcheck server 116 for verification with the repository 118. The hashcheck server 116 may search for string passwords, optionally using a regular expression in a sharepoint 112 or other fileshare 114. This search may be done using encrypted data or after decrypting data, in some examples.

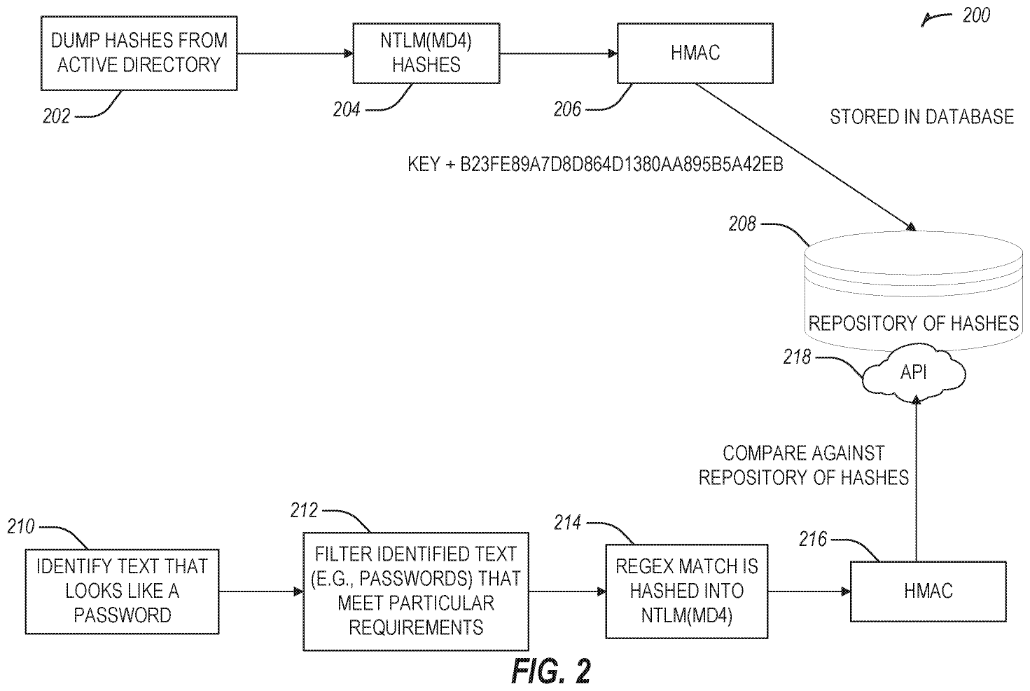

FIG. 2 illustrates a block diagram 200 for evaluating text data for presence of a hashed password in accordance with some examples. The block diagram 200 shows an example implementation using a particular key and a set of NTLM hashes. For example, at block 202, a set of hashes may be obtained from an active directory. At block 204, the set of hashes may be searched for hashes that were generated using NTLM (e.g., a message digest algorithm, such as MD4). At block 206, the set of hashes may be searched for hashes that were generated using HMAC. When a string is identified, as in the example shown in block diagram 200, which includes a key and a string “B23FE89A7D8D864D1380AA895B5A42EB,” the hash may be stored in a repository of hashes 208.

At block 210, a text string may be identified as potentially including a hash. For example a detection system may be used to identify the text string. The text string that potentially includes the hash may be filtered at block 212. The filtering may include limiting string length, removing data that cannot be a result of hashes used to store passwords at an enterprise, or the like. The remaining string may be matched to a set of data (e.g., an NTLM hash or an HMAC hash at blocks 214 or 216, respectively). In an example, block 214 or 216 may include using a regular expression (regex) to determine whether the remaining string includes a match. The regex match may include identifying a partial match. Matching may occur by comparing the remaining string to hashes in the repository of hashes 208, for example via an API 218.

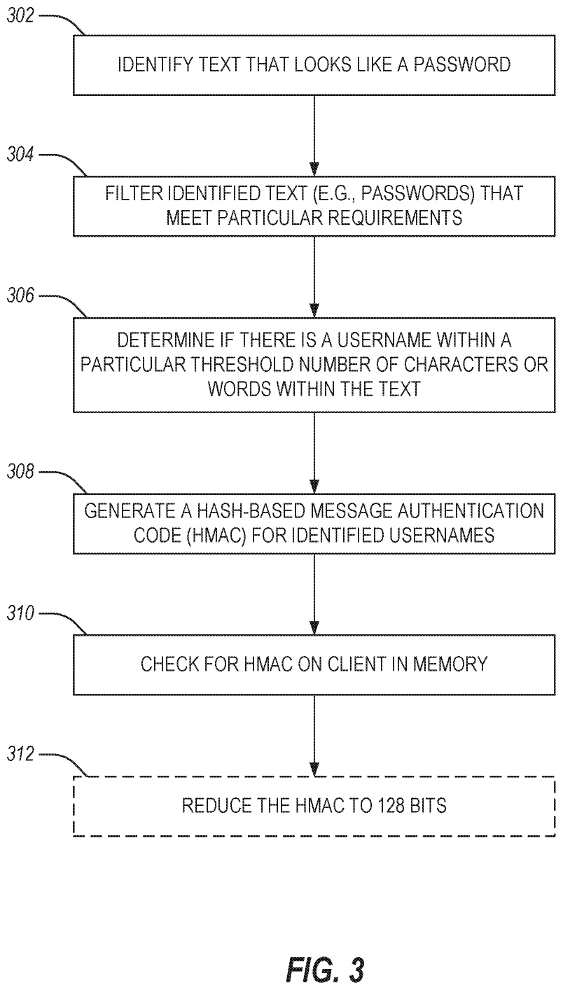

FIG. 3 illustrates a flowchart showing a technique 300 for evaluating text data for presence of a username in accordance with some examples.

The technique 300 includes an operation 302 to identify text (e.g., a string of characters) that matches a set of parameters (e.g., a subset of a set of possible parameters) that indicate the text may include a password (e.g., as hashed or otherwise encrypted). The technique 300 includes an operation 304 to filter the identified text (e.g., a password) that matches the set of parameters.

The technique 300 includes an operation 306 to use contextual information to determine whether the identified text includes a password or other secure information. For example, operation 306 may include determining whether there is a username within a particular threshold number of characters or words within the text suspected to be a password or secure information (e.g., within 5 words of the text). Other contextual information may include identification of a keyword, such as “password” or “social security” that may trigger further consideration of the identified text. Other contextual information may include identifying a user saving or sending the information, a user receiving or accessing the information, a time of day, etc.

The technique 300 may include an operation 308 to generate a hash-based message authentication code (HMAC) for an identified username. The HMAC may be compared to a repository or other storage location or memory in operation 310, for example to determine whether the username is a username of a particular enterprise. When the username is part of the particular enterprise, the identified text that may include a password or other secure information may be flagged or compared to a repository of encrypted data to determine whether the secure information is being shared or stored inappropriately. The HMAC may be optionally reduced to 128 bits at operation 312, for example according to enterprise preferences, or for reducing searching burden.

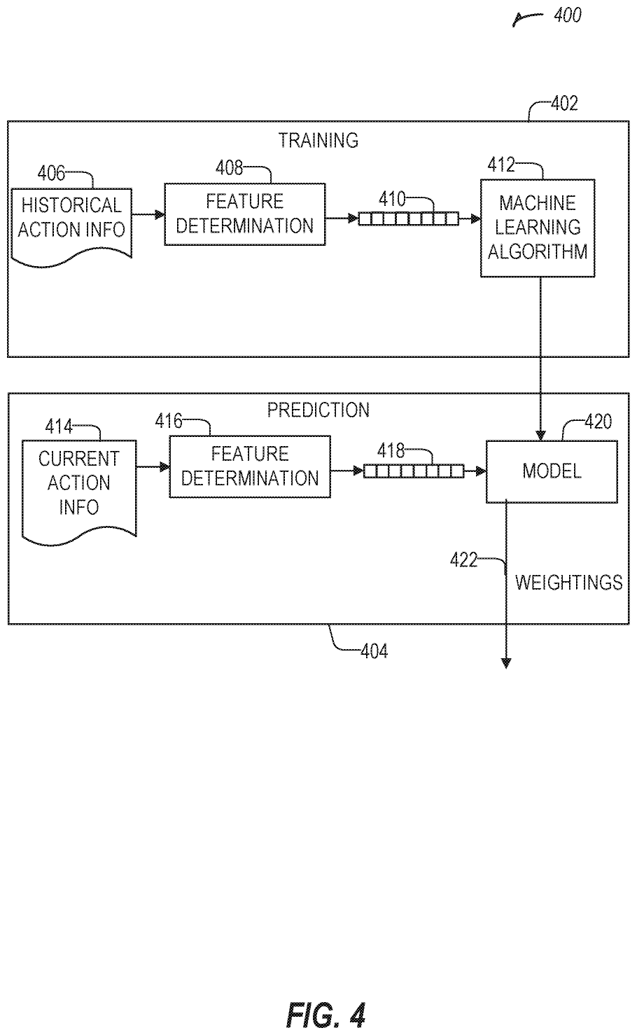

FIG. 4 illustrates a machine learning engine for evaluating text data for password matching in accordance with some examples. A system may calculate one or more weightings for criteria based upon one or more machine learning algorithms. FIG. 4 shows an example machine learning engine 400 according to some examples of the present disclosure.

Machine learning engine 400 utilizes a training engine 402 and a prediction engine 404. Training engine 402 inputs historical information 406, such as hashed or otherwise encrypted strings, non-hashed or non-encrypted strings, or the like, into feature determination engine 408. The historical information 406 may be labeled with an indication, such as whether the input string is encrypted or not, hashed or not, a type of encryption or hashing used, or the like.

Feature determination engine 408 determines one or more features 410 from the historical information 406. Stated generally, features 410 are a set of the information input and is information determined to be predictive of a particular outcome. Example features are given above. In some examples, the features 410 may be all the historical activity data, but in other examples, the features 410 may be a subset of the historical activity data. The machine learning algorithm 412 produces a model 420 based upon the features 410 and the labels.

In the prediction engine 404, current information 414 (e.g., a text string) may be input to the feature determination engine 416. Feature determination engine 416 may determine the same set of features or a different set of features from the current information 414 as feature determination engine 408 determined from historical information 406. In some examples, feature determination engine 416 and 408 are the same engine. Feature determination engine 416 produces feature vector 418, which is input into the model 420 to generate one or more criteria weightings 422. The training engine 402 may operate in an offline manner to train the model 420. The prediction engine 404, may be designed to operate in an online manner. In some examples, the model 420 may be periodically updated via additional training or user feedback (e.g., an update to a technique or procedure).

The machine learning algorithm 412 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example, a regression model is used and the model 420 is a vector of coefficients corresponding to a learned importance for each of the features in the vector of features 410, 418.

Once trained, the model 420 may output whether a text string includes potentially encrypted or hashed data. Data input sources for the model 420 may include emails, texts, data from a communication application, stored documents, file repositories, servers, devices, or the like. In some examples, the model 420 may be updated, for example with validation data based on whether an output indication of a text string being encrypted or hashed was correct or incorrect.

In some examples, a classifier, a natural language processing model, a large language model, or the like may be used to recognize whether an input string is encrypted text. Text may be filtered before being input to a model, such as by character count (e.g., a 64 bit string), by features of the text (e.g., a hexadecimal string), by context related to the text, such as a nearby username, a sender or author, a receiver, a storage location, a communication channel, or the like. For example, presence of a username may indicate more strongly that text includes a password. Storage of a document in a relatively secure storage location (e.g., a location requiring a password to access) may indicate text in the document includes secure text.

In some examples, a model may be trained using input encrypted text and corresponding unencrypted text, with the encrypted text labeled with an encryption type. In some examples, the model may output an encryption type based on an encrypted input. In other examples, the model may output an indication that input text is encrypted, or likely encrypted according to a probability (which may be optionally output by the model).

In some examples, an enterprise may hash data using a locality preserving hash function. For example, sequential passwords for a particular user may be hashed according to the locality preserving hash function such that the sequential passwords generate hashes that are close to each other. In these examples, when a user has a history of identity theft or password exposure, subsequent passwords may be monitored in hashed format automatically (e.g., by monitoring for any hashes within a particular locality range).

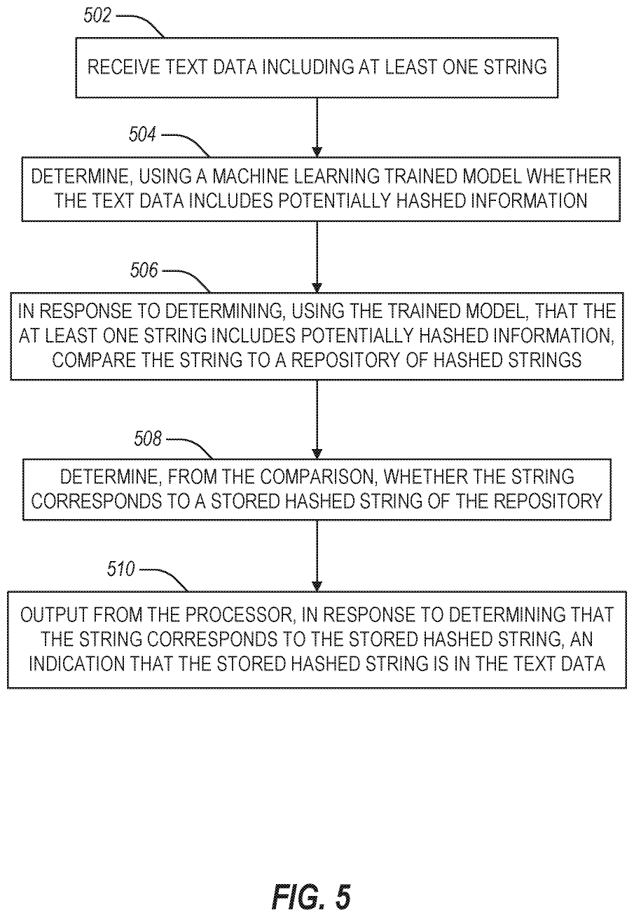

FIG. 5 illustrates a flowchart showing a technique 500 for identifying a hashed password in text in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1.

The technique 500 includes an operation 502 to receive text data including at least one string. The text data may be extracted, for example from monitored emails or traffic over a network. In some examples, the string may be encrypted. The text data may include one or more of an API key, a password, a PIN, a passphase, a credit card number, a bank account number, personal health information, or the like. The technique 500 includes an operation 504 to determine, using a machine learning trained model whether the text data includes potentially hashed information.

The technique 500 includes an operation 506 to in response to determining, using the trained model, that the at least one string includes potentially hashed information, compare the string to a repository of hashed strings. Comparing the string to the repository of hashed strings includes using an edit distance, a hamming distance, a Locality Sensitive Hash, a Bloom Filter, or the like. In some examples, comparing the string includes using a bit-wise comparison between the string and hashed strings in the repository. The repository may include an active directory, a hashed password database, an internet password repository, or the like. In an example, before operation 506, the technique 500 may include filtering the text data based on a set of password requirements (e.g., password requirements of an enterprise, company, group, etc.). The password requirements may include length, character type, encryption type or length, etc.

The technique 500 includes an operation 508 to determine, from the comparison, whether the string corresponds to a stored hashed string of the repository. In some examples, the stored hashed string may be encrypted. The technique 500 includes an operation 510 to output from the processor, in response to determining that the string corresponds to the stored hashed string, an indication that the stored hashed string is in the text data.

The technique 500 may include blocking an email corresponding to the extracted text data based on an identified hashed password (e.g., the stored hashed string) corresponding to the string. The technique 500 may include disabling a password corresponding to the string (e.g., when the stored hashed string is a password).

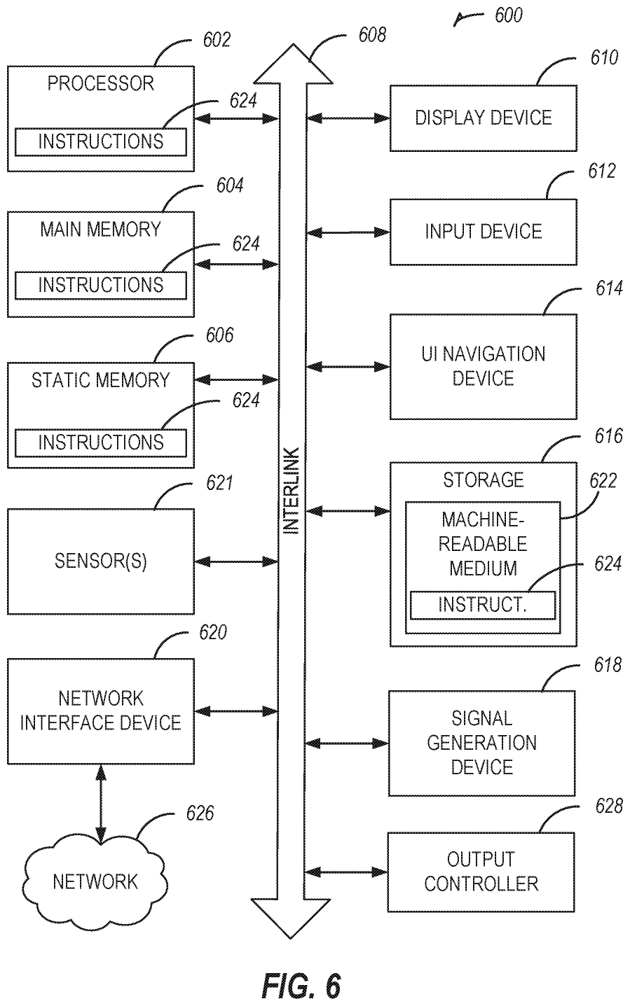

FIG. 6 illustrates generally an example of a block diagram of a machine 600 upon which any one or more of the techniques (e.g., methodologies) discussed herein may perform in accordance with some examples. In alternative examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving, at a processor, text data including a string; determining, using a machine learning trained model whether the text data includes, potentially hashed information; in response to determining, using the trained model, that the string includes potentially hashed information, comparing the string to a repository of hashed strings; determining, from the comparison, whether the string corresponds to a stored hashed string of the repository; and outputting from the processor, in response to determining that the string corresponds to the stored hashed string, an indication that the stored hashed string is in the text data.

In Example 2, the subject matter of Example 1 includes, wherein receiving the text data includes extracting the text data from monitored emails or traffic over a network.

In Example 3, the subject matter of Example 2 includes, blocking an email corresponding to the extracted text data based on an identified hashed password corresponding to the string.

In Example 4, the subject matter of Examples 1-3 includes, wherein comparing the string to the repository of hashed strings includes using an edit distance, a hamming distance, a Locality Sensitive Hash, or a Bloom Filter.

In Example 5, the subject matter of Examples 1-4 includes, wherein comparing the string to the repository of hashed strings includes using a bit-wise comparison between the string and hashed strings in the repository.

In Example 6, the subject matter of Examples 1-5 includes, disabling a password corresponding to the string.

In Example 7, the subject matter of Examples 1-6 includes, wherein the string and the stored hashed string are encrypted.

In Example 8, the subject matter of Examples 1-7 includes, wherein the text data includes at least one of an API key, a password, a PIN, a passphase, a credit card number, a bank account number, or personal health information.

In Example 9, the subject matter of Examples 1-8 includes, wherein the repository is an active directory, a hashed password database, or an internet password repository.

In Example 10, the subject matter of Examples 1-9 includes, before comparing the string to the repository of hashed strings, filtering the text data based on a set of password requirements.

Example 11 is at least one non-transitory machine-readable medium including instructions, which when executed by processing circuitry, causes the processing circuitry to perform operations to: receive, at a processor, text data including a string; determine, using a machine learning trained model whether the text data includes, potentially hashed information; in response to determining, using the trained model, that the string includes potentially hashed information, compare the string to a repository of hashed strings; determine, from the comparison, whether the string corresponds to a stored hashed string of the repository; and output from the processor, in response to determining that the string corresponds to the stored hashed string, an indication that the stored hashed string is in the text data.

In Example 12, the subject matter of Example 11 includes, wherein to receive the text data, the instructions cause the processing circuitry to extract the text data from monitored emails or traffic over a network.

In Example 13, the subject matter of Example 12 includes, instructions causing the processing circuitry to block an email corresponding to the extracted text data based on an identified hashed password corresponding to the string.

In Example 14, the subject matter of Examples 11-13 includes, wherein to compare the string to the repository of hashed strings, the instructions cause the processing circuitry to use an edit distance, a hamming distance, a Locality Sensitive Hash, or a Bloom Filter.

In Example 15, the subject matter of Examples 11-14 includes, wherein to compare the string to the repository of hashed strings, the instructions cause the processing circuitry to use a bit-wise comparison between the string and hashed strings in the repository.

In Example 16, the subject matter of Examples 11-15 includes, instructions causing the processing circuitry to disable a password corresponding to the string.

In Example 17, the subject matter of Examples 11-16 includes, wherein the string and the stored hashed string are encrypted.

In Example 18, the subject matter of Examples 11-17 includes, wherein the text data includes at least one of an API key, a password, a PIN, a passphase, a credit card number, a bank account number, or personal health information.

In Example 19, the subject matter of Examples 11-18 includes, wherein the repository is an active directory, a hashed password database, or an internet password repository.

In Example 20, the subject matter of Examples 11-19 includes, instructions causing the processing circuitry to, before comparing the string to the repository of hashed strings, filter the text data based on a set of password requirements.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, at a processor, text data including a string;
determining, using a machine learning trained model whether the text data includes potentially hashed information;
in response to determining, using the trained model, that the string includes potentially hashed information, comparing the string to a repository of hashed strings;
determining, from the comparison, whether the string corresponds to a stored hashed string of the repository; and
outputting from the processor, in response to determining that the string corresponds to the stored hashed string, an indication that the stored hashed string is in the text data.

2. The method of claim 1, wherein receiving the text data includes extracting the text data from monitored emails or traffic over a network.

3. The method of claim 2, further comprising blocking an email corresponding to the extracted text data based on an identified hashed password corresponding to the string.

4. The method of claim 1, wherein comparing the string to the repository of hashed strings includes using an edit distance, a hamming distance, a Locality Sensitive Hash, or a Bloom Filter.

5. The method of claim 1, wherein comparing the string to the repository of hashed strings includes using a bit-wise comparison between the string and hashed strings in the repository.

6. The method of claim 1, further comprising disabling a password corresponding to the string.

7. The method of claim 1, wherein the string and the stored hashed string are encrypted.

8. The method of claim 1, wherein the text data includes at least one of an API key, a password, a PIN, a passphase, a credit card number, a bank account number, or personal health information.

9. The method of claim 1, wherein the repository is an active directory, a hashed password database, or an internet password repository.

10. The method of claim 1, further comprising, before comparing the string to the repository of hashed strings, filtering the text data based on a set of password requirements.

11. At least one non-transitory machine-readable medium including instructions, which when executed by processing circuitry, causes the processing circuitry to perform operations to:
receive, at a processor, text data including a string;
determine, using a machine learning trained model whether the text data includes potentially hashed information;
in response to determining, using the trained model, that the string includes potentially hashed information, compare the string to a repository of hashed strings;
determine, from the comparison, whether the string corresponds to a stored hashed string of the repository; and
output from the processor, in response to determining that the string corresponds to the stored hashed string, an indication that the stored hashed string is in the text data.

12. The at least one machine-readable medium of claim 11, wherein to receive the text data, the instructions cause the processing circuitry to extract the text data from monitored emails or traffic over a network.

13. The at least one machine-readable medium of claim 12, further comprising instructions causing the processing circuitry to block an email corresponding to the extracted text data based on an identified hashed password corresponding to the string.

14. The at least one machine-readable medium of claim 11, wherein to compare the string to the repository of hashed strings, the instructions cause the processing circuitry to use an edit distance, a hamming distance, a Locality Sensitive Hash, or a Bloom Filter.

15. The at least one machine-readable medium of claim 11, wherein to compare the string to the repository of hashed strings, the instructions cause the processing circuitry to use a bit-wise comparison between the string and hashed strings in the repository.

16. The at least one machine-readable medium of claim 11, further comprising instructions causing the processing circuitry to disable a password corresponding to the string.

17. The at least one machine-readable medium of claim 11, wherein the string and the stored hashed string are encrypted.

18. The at least one machine-readable medium of claim 11, wherein the text data includes at least one of an API key, a password, a PIN, a passphase, a credit card number, a bank account number, or personal health information.

19. The at least one machine-readable medium of claim 11, wherein the repository is an active directory, a hashed password database, or an internet password repository.

20. The at least one machine-readable medium of claim 11, further comprising instructions causing the processing circuitry to, before comparing the string to the repository of hashed strings, filter the text data based on a set of password requirements.
